(19) United States
(12) Patent Application Publication
(10) Pub. No.: US 2016/0332148 A1
(43) Pub. Date: Nov. 17, 2016

(54) A Catalyst for Direct Synthesis of Hydrogen Peroxide

(71) Applicant: SOLVAY SA, Brussels (BE)

(72) Inventors: Frédérique DESMEDT, Brussels (BE); Pierre MIQUEL, Roubaix (FR); Paul DESCHRIJVER, Lennik (BE); Yves VLASSELAER, Leefdaal (BE)

(73) Assignee: SOLVAY SA, Brussels (BE)

(21) Appl. No.: 15/112,844

(22) PCT Filed: Jan. 20, 2015
(86) PCT No.: PCT/EP2015/050923

§ 371 Date: Jul. 20, 2016

(30) Foreign Application Priority Data
Jan. 24, 2014 (EP) 14152454.6

(51) Int. Cl. B01J 23/652; B01J 35/02; C01B 15/029; B01J 35/00

(52) U.S. Cl. CPC B01J 23/6527; B01J 35/0006; B01J 35/023; C01B 15/029

(57) ABSTRACT

The present invention provides a catalyst comprising a platinum group metal (group 10) on a carrier, said carrier comprising a silica core and a precipitate layer of a metal oxide, sulfate or phosphate on said core; said carrier having at least on the surface of the precipitate, a dispersion of an oxide from a metal chosen from W, Mo, Ta and Nb, the metal in said dispersion being different from the metal in the precipitate. The invention also relates to a process for producing hydrogen peroxide, comprising reacting hydrogen and oxygen in the presence of the catalyst according to the invention in a reactor.

This application claims priority to European application No. EP 14152454.6 filed on Jan. 24, 2014, the whole content of this application being incorporated herein by reference for all purposes.

### TECHNICAL FIELD

This invention relates to a catalyst for the direct synthesis of hydrogen peroxide and to a process for producing hydrogen peroxide, comprising reacting hydrogen and oxygen in the presence of the catalyst according to the invention.

### STATE OF THE ART

Hydrogen peroxide is a highly important commercial product widely used as a bleaching agent in the textile or paper manufacturing industry, a disinfecting agent and basic product in the chemical industry and in the peroxide compound production reactions (sodium perborate, sodium percarbonate, metallic peroxides or percarboxyl acids), oxidation (amine oxide manufacture), epoxidation and hydroxylation (plasticizing and stabilizing agent manufacture).

Commercially, the most common method to produce hydrogen peroxide is the “anthraquinone” process. In this process, hydrogen and oxygen react to form hydrogen peroxide by the alternate oxidation and reduction of alkylated anthraquinones in organic solvents. A significant disadvantage of this process is that it is costly and produces a significant amount of by-products that must be removed from the process.

One highly attractive alternative to the anthraquinone process is the production of hydrogen peroxide directly by reacting hydrogen and oxygen in the presence of metal catalysts supported on various oxides such as silica as a catalyst carrier.

However, in these processes, when a catalyst based on silica as carrier is used for the direct synthesis of hydrogen peroxide, the reaction product, i.e., hydrogen peroxide was not efficiently produced since the production of water as a by-product is very high and even higher than the hydrogen peroxide production after a certain period of time.

To prevent these drawbacks, alternative processes based on other carriers where developed, but they generally suffer from a very poor mechanical behavior of this catalyst since it is fragile and shows a significant attrition. Examples of such carriers are metal oxides like Zr, Nb and Ta oxides; and sulfates and phosphates of alkaline-earth metals like BaSO4.

Therefore, mixed catalysts were developed wherein metal oxides, sulfates and phosphates were supported (precipitated) on silica to form a carrier for an active metal generally comprising palladium: see for instance WO 2013/068243 (Zr oxide on silica), WO 2013/068340 (Nb and Ta oxides on silica) and co-pending application PCT/EP2013/072020 (sulfates and phosphates of alkaline-earth metals on silica) all in the name of the Applicant.

Although all these catalysts have a high selectivity and a good mechanical resistance, it has been found however that their selectivity decreases over time probably because the active metal is at the same time leaching out and making aggregates at the surface of the catalyst.

U.S. Pat. No. 6,346,228 describes a multicomponent catalyst comprising a hydrophobic polymer membrane deposited on a Pd containing acidic catalyst which can be obtained by a process comprising a first step which consists in depositing MOₙ on the surface of a catalytic porous solid, wherein M is an element selected from S, Mo, W, Ce, Sn, P or a mixture thereof. In one example, a selectivity of 61% could be obtained after 3 hours reaction. This document is silent about long term selectivity.

Therefore, it is an object of the present invention to provide a catalyst for the direct synthesis of hydrogen peroxide, which has a high selectivity which is stable over time.

This object could be reached thanks to the fact of putting on the surface of the carrier, besides the metal oxide, sulfate or phosphate precipitate, an oxide from another metal chosen from W, Mo, Ta and Nb and which is different from the metal in the precipitate.

Therefore, the present invention relates to a catalyst comprising a platinum group metal (group 10) on a carrier, said carrier comprising a silica core and a precipitate layer of comprising a metal oxide, sulfate or phosphate on said core; said carrier having at least on the surface of the precipitate, a dispersion of an oxide from a metal chosen from W, Mo, Ta and Nb, the metal in said dispersion being different from the metal in the precipitate.

### DETAILED DESCRIPTION OF THE INVENTION

The expression “carrier” intends herein to denote the material, usually a solid with a high surface area, to which the catalytic metal is affixed.

According to the invention, this carrier comprises a silica core and a precipitate layer thereon. In such a structure, the catalytic metal is in fact deposited on the precipitate layer and the silica only acts as mechanical support for the latter. The silica can essentially be amorphous like a silica gel or can be comprised of an orderly structure of mesopores, such as, for example, of types including MCM-41, MCM-48 and SBA-15. Good results were obtained with silica gel.

Generally, said support has a BET surface of at least 100 m2/g, preferably of at least 200 m2/g. Generally, said support has a pore diameter of more than 5 nm but less than 50 nm, preferably in the range of 10 nm. It also generally has a total pore volume of more than 0.1 ml/min but less than 5 ml/min, preferably in the range of 1 mug.

In specific embodiments of the present invention, the amount of silica is from 30 to 99 wt. %, more preferably from 50 to 98 wt. % and most preferably from 70 to 95 wt. %, based on the total weight of the carrier. Hence, in this embodiment, the amount of precipitate is generally from 1 to 70 wt. %, more preferably from 2 to 50 wt. % and most preferably from 5 to 30 wt. %, based on the total weight of the carrier. In practice, an amount of precipitate of from 1 to 15 wt. %, more preferably from 2 to 10 wt. % and most preferably from 3 to 8 wt. %, based on the total weight of the carrier, gives good results.

Generally, the silica core comprises particles having a mean diameter in the range of 50 μm to 5 mm, preferably from 100 μm to 4 mm and even more preferably, from 150 μm to 3 mm. In practice, good results are obtained with a mean particle size in the range of the hundreds of μm. This particle size is based on laser diffraction measurements on the particles in suspension in a liquid, more specifically using a laser Coulter LS230 apparatus based on a wave length of 750 nm for the incident light. The size distribution is calculated in % in volume.

According to the invention, the silica core has a precipitate comprising (and preferably being substantially made of) a metal oxide, sulfate or phosphate on it. The metal oxide is preferably chosen from Zr, Nb and Ta oxides (like in the above mentioned applications WO 2013/068243 and WO 2013/068340, the content of which is incorporated by reference in the present application). The metal sulfate or phosphate preferably is an alkaline-earth metal sulfate of phosphate, more preferably BaSO4 (like in the above mentioned application PCT/EP2013/072020, the content of which being also incorporated by reference in the present application).

A precipitate layer comprising ZrO₂ gives good results in the present invention.

The precipitation of ZrO₂ on the silica core may be accomplished by a variety of techniques known in the art. One such method involves impregnating the silica with a precursor of zirconium oxide e.g., ZrOCl₂, optionally followed by drying. The zirconium oxide precursor may include any suitable zirconium hydroxide, zirconium alkoxide, or zirconium oxyhalide (such as ZrOCl₂).

In a preferred embodiment, the precursor of zirconium oxide is an oxyhalide of zirconium, preferably zirconium oxychloride. The precursor is converted, for example after hydrolysis followed by heat treatment, to zirconium oxide, which is precipitated onto the silica core to produce the carrier.

The precipitate of the invention can be a continuous or discontinuous layer on the silica core. Generally, part of the silica particles of which the core is made, are covered by the precipitate. Said precipitate generally also comprises particles, generally of substantially spherical shape, generally having a mean particle size in the range of 10 nm.

The inventors have surprisingly discovered that by dispersing an oxide of a metal chosen from W, Mo, Ta and Nb at least on the surface of the carrier already bearing the precipitate on its surface, both the high-productivity and selectivity which can be obtained with the above carrier can be maintained constant. Without willing to be bound to a theory, this might be because these metals, which have a high atomic number, act as spacers for the Pd atoms which are supported on the carrier and by doing so, prevent the above mentioned formation of Pd aggregates during reaction. W gives good results in that regard.

Of course, to be able to act as spacers on the precipitate, the metal in said precipitate should be different from the one of the dispersion. Also, the amount of the latter (i.e. of the metal of the dispersion) in the carrier (expressed in weight of pure metal versus the total weight of the carrier) should be low, typically below 1000 ppm, preferably below 500 ppm even more preferably below 200 ppm. Its amount is preferably above 10 ppm, more preferably above 20 ppm, even more preferably above 30 ppm. Values between 10 and 200 ppm, preferably between 15 and 150 and more preferably between 20 and 100 pp give good results in practice.

Finally, it is important that said dispersion is at least present on the surface of the carrier, which does not preclude that it may also be present in depth in it and even, be dispersed in the entire precipitate. However, it is preferably substantially on the surface of the precipitate.

By “dispersion at least at the surface” is in fact meant that W, Mo, Ta or Nb oxide particles/aggregates are at the surface of the carrier, on its precipitate layer. These particles/aggregates generally are composed of only few metal oxide molecules. They are generally in the range of the Angstroms. Besides, after analysis, it appeared that when the precipitate layer is not continuous, said molecules are predominantly located onto the precipitate so that in practice, said precipitate could be qualified as being “doped” with W, Mo, Ta or Nb oxide.

Preferably, the dispersion (preferably of W) is obtained by precipitating a metal precursor (like W ethoxide, for instance in an alcoholic solution, or W salts like W (VI) chloride, W (VI) dichloride dioxide, W (VI) fluoride, W (VI) oxychloride, W (VI) oxybromide) on the carrier. Other methods for obtaining the dispersion are grafting, impregnation followed by hydrolysis, impregnation followed by calcination, dry-mixing, co-precipitation.

The catalyst of the invention comprises a metal from group 10 (platinum group), preferably Pt or Pd, more preferably Pd which may be used as only catalytic metal or in combination with Pt and/or Au.

The amount of metal of group 10 supported to the carrier can vary in a broad range, but be preferably comprised from 0.001 to 10 wt. %, more preferably from 0.1 to 5 wt. % and most preferably from 0.5 to 3 wt. %, each based on the weight of the carrier. The addition of the metal of group 10 to the carrier can be performed using any of the known preparation techniques of supported metal catalyst, e.g. impregnation, adsorption, ionic exchange, etc. For the impregnation, it is possible to use any kind of inorganic or organic salt or the metal to be impregnated that is soluble in the solvent used in addition to the metal. Suitable salts are for example halide such as chlorides, acetate, nitrate, oxalate, etc.

The platinum group metal may be deposited by various ways known in the art. For example, the metal can be deposited by dipping the carrier to a solution of halides of the metal followed by reduction. In more specific embodiments, the reduction is carried out in the presence of a reducing agent, preferably gaseous hydrogen at high temperature.

The catalyst according to the invention has a large specific surface area determined by the BET method, generally greater than 20 m²/g, preferably greater than 100 m²/g.

In the second aspect of this invention, the invention is also directed to the use of the catalyst according to the invention in production of hydrogen peroxide by direct synthesis. In the process of the invention, hydrogen and oxygen (as purified oxygen or air) are reacted continuously over a catalyst in the presence of a liquid solvent in a reactor to generate a liquid solution of hydrogen peroxide. The catalyst is then used for the direct synthesis of hydrogen peroxide in a three phase's system: the catalyst (solid) is put in a solvent (alcohol or water) and the gases (H₂, O₂ and an inert gas) are bubbled in the suspension in presence of stabilizing additives (halides and/or inorganic acid). In these processes, H⁺ and Br⁻ ions are generally required in the reaction medium in order to obtain high concentrations of hydrogen peroxide. These ions are obtained from strong acids, such as sulfuric, phosphoric, hydrochloric or nitric acids and inorganic bromides.

In other embodiments, the catalyst of the invention may be also used for the synthesis of hydrogen peroxide by the anthraquinone process.

In the third aspect of the invention, a process for producing hydrogen peroxide, comprising: reacting hydrogen and oxygen in the presence of the catalyst according to the invention in a reactor, is provided. The process of this invention can be carried out in continuous, semi-continuous or discontinuous mode, by the conventional methods, for example, in a stirred tank reactor with the catalyst particles in suspension, in fixed bed reactor, in a basket-type stirred tank reactor, etc. Once the reaction has reached the desired conversion levels, the catalyst can be separated by different known processes, such as, for example, by filtration if the catalyst in suspension is used, which would afford the possibility of its subsequent reuse. In this case the amount of catalyst used is that necessary to obtain a concentration 0.01 to 10 wt. % regarding the solvent and preferably being 0.1 to 5 wt. %. The concentration of the obtained hydrogen peroxide according to the invention is generally higher than 5 wt. %, preferably higher than 7 wt. %.

Throughout the description and the claims, the word “comprises” and the variations thereon do not intend to exclude other technical features, additives, components or steps. For the experts in this field, other objects, advantages and characteristics of the invention will be inferred in part from the description and in part from the embodiment of the invention. The following examples are provided for illustrative purposes and are not intended to be limiting the scope of the present invention.

### Example 1

### Catalyst Synthesis

A. In a beaker of 1 liter, we introduced 400 cc of demineralized water and added 2 drops of NH4OH 25% Wt to reach a pH around 8.5. Silica (50.42 g Silica Yongji—average particles size 153 microns) was introduced and mechanically stirred (around 250 rpm). The suspension was heated at 50° C. When the temperature was stable, the pH was rectified to reach 8.3-8.5.

14.75 g of ZrOCl2 were dissolved at room temperature in 26.83 g of demineralized water. The solution of ZrOCl2 was introduced slowly in the suspension with a syringe pump (all the solution being introduced in +/−30 minutes). At the same time, the pH was maintained between 8.3 and 8.5 by adding some drops of NH4OH 25% Wt.

The suspension was then let under stirring at 50° C. during one hour.

It was then left at room temperature during 20 minutes without stirring.

The suspension was filtered and the solid was washed with 500 cc demineralized water.

The solid was dried 24 hours at 95° C. and calcined at 600° C. during 3 hours.

This carrier was called carrier A-1.

B. 24.80 g of this carrier A-1 was put in a glass reactor of 1 L equipped with a nitrogen inlet and a mechanical stirrer.

600 ml of dried hexane was added to the solid in order to help the dispersion of the W ethoxide in all the catalyst and to avoid that the ethoxide is hydrolyzed before it has been dispersed homogeneously in the carrier. The suspension was stirred at 250 rpm at room temperature, under a slight flux of nitrogen (in the range of the ml/min).

0.15 g of W ethoxide (W(OCH2-CH3)3), 5% Wt in ethanol was added to the suspension. The suspension was left under stirring during three hours. The hexane was evaporated under vacuum (rotavapor).

250 ml of demineralized water was added to the solid.

60 ml of nitric acid 0.5M was slowly added to the suspension (with a syringe pump). The suspension was aged during one night at room temperature.

The solid was dried under vacuum (in a rotavapor); it was washed with demineralized water, dried at 95° C. during one night and calcined at 600° C. during 3 hours.

This carrier was called carrier A-2.

C. 10.5 g of this carrier A-2 was impregnated with a solution of PdCl2 in water (0.31 g PdCl2 dissolved at 60° C. in 11 ml of demineralized water in presence of some drops (between 5 and 10) of HCl—37% Wt. The solid was dried at 95° C. during one night and reduced under hydrogen influence at 150° C. during 5 hours.

This catalyst was called catalyst A-2.

Its Pd content has been determined by ICP-OES (Inductively coupled plasma atomic emission spectroscopy) to be 1.55% Wt.

Its W content has been determined by ICP-OES as being 75 ppm, which corresponds to a content of about 76 ppm on the carrier.

Its Zr content has been determined by ICP-OES as being 3.70% Wt, which corresponds to a content of about 3.76% Wt on the carrier.

### Example 2

### Catalyst Synthesis

The same recipe as in Example 1 has been used with:

A. Water=400 cc

SiO2=52.08 g

ZrOCl2=14.80 g

Water=26.99 g

The first carrier was called carrier B-1.

B. Carrier B-1=25.39 g

Hexane=600 ml

W ethoxide in EtOH solution=0.04 g

The second carrier was called carrier B-2.

C. Carrier B-2=10 g

PdCl2=0.3080 g

Water=14.7 ml

The catalyst was called catalyst B-2.

Its Pd content by ICP-OES was 1.10% Wt.

Its W content by ICP-OES was 30 ppm, which corresponds to a content of about 30.3 ppm on the carrier.

Its Zr by ICP-OES was 3.60% Wt, which corresponds to a content of about 3.64% Wt on the carrier.

A SEM analysis has been done on the catalyst B-2. The spherical grains have an average size of 120 to 190 microns. The surface of the grains is rough and covered with a deposit. This deposit is made of finer particles of several tens of nanometers.

EDX spectra and cartographies have been done on the sample. The deposit areas are enriched in Zr and in a smaller proportion in W and Hf (which is a well-known impurity of zirconia).

The conditions for these analyses were the following:

Catalyst grains were fixed on a double-sided adhesive carbon tab and coated with a thin carbon layer (carbon coater SPI Supplies) for electronic charge removal. The analyses were performed on a Zeiss Supra 55 field emission gun scanning electron microscope (FEG-SEM), equipped with an INCA 350 Oxford Instruments Energy Dispersive X-ray microanalysis (EDX) system.

The images were recorded at an accelerating voltage of 3 kV in the secondary electron mode (“SE2”, contrast due mainly to topography) and at an accelerating voltage of 20 kV in the backscattered electron mode (“AsB”, contrast due mainly to atomic number).

Wide area X-ray microanalyses of a collection of grains and of specific grains and X-ray mappings of C, O, Si, Zr, Pd, Cl, Ca, Hf and W elements at different magnifications were performed at 20 kV. The images associated to EDX spectra and X-ray mappings were recorded in the backscattered electron mode (“BSE”, contrast due mainly to atomic number).

### Example 3

### Catalyst Synthesis

### Counterexample

A catalyst based on carrier A-1 has been prepared by incipient wetness method: 0.6742 g PdCl2 has been diluted in 20 g of demineralized water in presence of some drops (between 5 and 10) of HCl, 37% Wt (dissolution at 50° C.). The solution has been put in contact with 20 g of the carrier A-1. The catalyst obtained has been dried overnight at 95° C.

Its Pd was reduced under influence of hydrogen at 150° C. during 5 hours.

Its Pd content has been determined by ICP-OES and was 1.80% Wt.

This catalyst was called catalyst A-1.

### Example 4

### Direct Synthesis of Hydrogen Peroxide

In a HC-22/250 cc reactor, methanol, hydrogen bromide, ortho-phosphoric acid (H3PO4) and catalyst were introduced, in the amounts indicated in the Tables below.

The reactor was cooled to 5° C. and the working pressure was set at 50 bars (obtained by introduction of nitrogen).

The reactor was flushed all the time of the reaction with the mix of gases: Hydrogen (3.6% Mol)/Oxygen (55.0% Mol)/Nitrogen (41.4% Mol). The total flow was 2708 mlN/min

When the composition of the gas phase coming out of the reactor was stable (which was checked by GC (Gas Chromatography) on line), the mechanical stirrer was started at 1200 rpm. GC on line was performed every 10 minutes to establish the composition of the gas phase coming out of the reactor out.

The results obtained are set forth in Tables 1 and 2 below.

Should the disclosure of any patents, patent applications, and publications which are incorporated herein by reference conflict with the description of the present application to the extent that it may render a term unclear, the present description shall take precedence.

TABLE 1
Examples of hydrogen peroxide direct synthesis

| | | Catalyst A-2 | Catalyst B-2 |
|---|---|---|---|
| Methanol | g | 149.58 | 150.45 |
| HBr | ppm | 14.60 | 14.52 |
| H₃PO₄ | M | 0.1 | 0.1 |
| Catalyst | g | 0.5533 | 0.5498 |
| Temperature | ° C. | 5 | 5 |
| Pressure | bar | 50 | 50 |
| Hydrogen | % Mol | 3.6 | 3.6 |
| Oxygen | % Mol | 55.0 | 55.0 |
| Nitrogen | % mol | 41.4 | 41.1 |
| Total flow | mlN/min | 2708 | 2708 |
| Speed | rpm | 1200 | 1200 |
| Contact time | min | 240 | 240 |
| Hydrogen peroxide fin | % Wt | 7.57 | 6.24 |
| Water fin | % Wt | 2.00 | 2.29 |
| Conversion fin | % | 16.8 | 23.9 |
| Selectivity init | % | 68 | 66 |
| Selectivity fin | % | 67 | 67 |

TABLE 2
Comparison with a catalyst without WO₃ doping

| | | Catalyst A-1 | Catalyst A-2 |
|---|---|---|---|
| Methanol | g | 220.10 | 149.58 |
| HBr | ppm | 16.3 | 14.60 |
| H₃PO₄ | M | 0.1 | 0.1 |
| Catalyst | g | 0.8010 | 0.5533 |
| Temperature | ° C. | 5 | 5 |
| Pressure | bar | 50 | 50 |
| Hydrogen | % Mol | 3.6 | 3.6 |
| Oxygen | % Mol | 55.0 | 55.0 |
| Nitrogen | % mol | 41.4 | 41.4 |
| Total flow | mlN/min | 3975 | 2708 |
| Speed | rpm | 1200 | 1200 |
| Contact time | Min | 240 | 240 |
| Hydrogen peroxide fin | % Wt | 7.08 | 7.57 |
| Water fin | % Wt | 3.84 | 2.00 |
| Conversion fin | % | 35.0 | 16.8 |
| Selectivity init | % | 61 | 68 |
| Selectivity fin | % | 49 | 67 |

1. A catalyst comprising a platinum group metal on a carrier, said carrier comprising a silica core, and a precipitate layer of a metal oxide, sulfate or phosphate on said core; said carrier having at least on the surface of the precipitate layer, a dispersion of an oxide of a metal selected from the group consisting of W, Mo, Ta and Nb, wherein the metal in the dispersion is different from the metal in the precipitate layer.

2. The catalyst according to claim 1, wherein the silica core comprises particles having a mean diameter of from 150 μm to 4 mm.

3. The catalyst according to claim 1, wherein the precipitate layer comprises ZrO₂.

4. The catalyst according to claim 1, wherein the silica core comprises silica particles and only part of the silica particles are covered by the precipitate layer.

5. The catalyst according to claim 1, wherein the precipitate layer comprises particles, generally of substantially spherical shape, generally having a mean particle size in the range of 10 nm.

6. The catalyst according to claim 1, wherein the dispersion of metal oxide comprises W oxide.

7. The catalyst according to claim 1, wherein the metal in the precipitate layer is present in an amount, expressed in weight of pure metal versus the total weight of the carrier, of below 1000 ppm.

8. The catalyst according to claim 1, wherein the metal in the precipitate layer is present in an amount, expressed in weight of pure metal versus the total weight of the carrier, of above 10 ppm.

9. The catalyst according to claim 1, wherein the metal in the precipitate layer is present in an amount, expressed in weight of pure metal versus the total weight of the carrier, of between 40 and 90 ppm.

10. The catalyst according to claim 1, wherein the dispersion comprises particles/aggregates each comprising only a few molecules the metal oxide.

11. The catalyst according to claim 10, wherein the layer is not continuous, said molecules are predominantly located on the precipitate layer so that said precipitate layer is doped with W, Mo, Ta or Nb oxide.

12. The catalyst according to claim 1, wherein the platinum group metal (group 10) comprises Pt or Pd, more preferably Pd which may be used as only catalytic metal or in combination with Pt and/or Au.

13. A process for producing hydrogen peroxide, comprising conducting a synthesis reaction in the presence of a catalyst according to claim 1.

14. The process according to claim 13, wherein the production of hydrogen peroxide is by direct synthesis.

15. The process according to claim 14, wherein the production of hydrogen peroxide comprises reacting hydrogen and oxygen in the presence of the catalyst according to claim 1.
